(19) United States
(12) Patent Application Publication
(10) Pub. No.: US 2003/0172042 A1
(43) Pub. Date: Sep. 11, 2003

(54) Mobile service system

(76) Inventor: Kyoko Agui, Kawasaki-Shi (JP)

Correspondence Address: DICKSTEIN SHAPIRO MORIN & OSHINSKY LLP, 41st Floor, 1177 Avenue of the Americas, New York, NY, 10036-2714, US

(21) Appl. No.: 10/378,614

(22) Filed: Mar. 5, 2003

(30) Foreign Application Priority Data
Mar. 5, 2002 (JP) 58350/2002

(51) Int. Cl. G06F 17/00

(52) U.S. Cl. 705/500

(57) ABSTRACT

The present system includes a car mounted communication terminal, which is mounted on a mobile shop, having an information processing function and connecting to the Internet, and a registered communication terminal of a user, which is registered in advance with the service supply by the user as a member user, for connecting to the car-mounted communication terminal over the Internet. When the mobile shop approaches a sales area, the car-mounted communication terminal calls and distributes sales information to the registered communication terminal within the sales area and receives order information for the sale information. The car-mounted communication terminal collects and records sold item information based on order information at a given sales base. The Internet may be a general communication terminal. The car-mounted communication terminal and the registered communication terminal can call and exchange information with each other.

### BACKGROUND OF THE INVENTION

1. Field of the Invention

The present invention relates to a system for providing mobile services to users by using a mobile service car and, in particular, to a mobile service system, which can improve the level of customer satisfaction with the service providing.

2. Description of the Related Art

Conventionally, a mobile shop service system is one of this kind of mobile service system.

In the conventional mobile shop service system, a mobile shop service car is used, and the car is driven at a low speed or is parked for a certain period of time at a certain place in residential areas, downtown and so on. Then, items for sale are announced and are sold. For most sales announcement, an audio announcement message is output from a speaker to attract customers.

Therefore, cooked foods can be served “hot”. “Fresh” row food can be provided. General items can be provided “at nearer areas and at lower prices” than door-to-door deliveries.

As shown in FIG. 1, most conventional mobile shops 120 are not systemized. In other words, the mobile shop 120 sent out from a sales office 110 and travels in a predetermined area or on a predetermined route as a service area 140. Then, a customer 130 responses to the announcement message from a speaker so as to be served. Therefore, in many cases, even systemized, small companies run this kind of business by having a sales register in the mobile shop 120 and an inventory system in the sales office 110.

The conventional mobile service systems including the mobile shop system have following problems.

First of all, a limited period of time is given for purchasing items. This is because a mobile shop may arrive at a predetermined place fast or late, that is, irregularly. Therefore, customers have to wait at the predetermined place for a certain time zone. In addition, the mobile shop must leave after a limited period of time to go to the next place.

Secondly, the service is hard for deaf people and people who cannot walk to use. This is because a mobile shop arrives irregularly and only the audio arrival notification is mainly given through a speaker. If windows are shut up, the even able-bodied people cannot hear the notification well. If a customer notices the arrival of the mobile shop too late, he/she may not catch the mobile shop.

Third, the mobile services are not certain and have low reliability. Many mobile shops do not present their contacts clearly, which may lower the reliability. Especially, small companies must try hard to establish trust with customers because their services are “irregular and moving”. In addition, customers may hardly use the irregular services repeatedly.

Finally, some mobile services are against public welfare. People's patterns of living vary in different ways. Complaints have been caused against the customer gathering through audio announcement by using speakers even during the daytime.

### SUMMARY OF THE INVENTION

Accordingly, it is an object of the present invention to solve these problems, for example. In other words, it is an object of the present invention to provide a mobile service system, which can improve the level of customer satisfaction with mobile service providing and, furthermore, which can contribute to public welfare.

In a mobile service system according to the present invention, for example, a mobile shop service system may be used to sell breads, baked potatoes, tofu, lunch boxes, household utensils and so on to users by using an individual mobile shop service car or by using mobile shop service cars belonging to an association. In this case, when a mobile shop approaches to a predetermined place, the mobile shop calls and notifies to communication terminals of member users over a network in order to receive orders. According to the system, the business transaction is performed in the predetermined place. Furthermore, deliveries to or rounds of homes of the member users are also possible.

A mobile service system according to the present invention includes a communication network, a car-mounted communication terminal, which is mounted in a mobile service car, for holding service information, customer information and mobile service information in a database in advance, connecting to the communication network and having an information processing function, and a registered communication terminal of the member user, which is registered with the mobile service by the user as the member user in advance, for bi-directionally communicating with the car-mounted communication terminal over the communication network.

With this structure, the member user can use the registered communication terminal while staying at home to exchange information with the car-mounted communication terminal in the mobile service car over the communication terminal.

The mobile service car may have a car navigation system. Therefore, the car-mounted communication terminal can register a service area with the car navigation system in advance. Then, the registered communication terminal within the service area can be called.

The registered communication terminal can have an e-mail function and notify to the member user in response to a predetermined call signal when the registered communication terminal is called from the car-mounted communication terminal, such as a lamp lighting-up terminal for hearing-impairing people, an intercom system terminal including high functions, a facsimile terminal, a personal computer and a mobile phone terminal.

Here, the predetermined call signal may be at least one of flashing of a light source, sound, voice, and vibration. Therefore, the car-mounted communication terminal has an interface function for interconnecting with registered communication terminal to be called.

In a mobile shop service system, which is one concrete system according to the present invention, the mobile service car may be a mobile shop, the mobile service may be a mobile shop service, and the service information may be item information. Here, a sales headquarters is provided for holding item information, customer information and mobile shop information in a database in advance.

Therefore, the sales headquarters may register, in the customer information, a predetermined registration requested by a communication terminal of a user, distribute sales promotion information to the registered communication terminal as required, answer to an inquiry from the registered communication terminal, register predetermined information received from the car-mounted communication terminal in the database, update the predetermined information in the database as necessary, and share the registered data with the car-mounted communication terminal.

When the mobile shop approaches a predetermined sales area, the car-mounted communication terminal may call and distribute sales information to the registered communication terminal of at least one member user within the sales area, receive order information for the sales information, and collect and record information on sold-item information input by a salesperson based on received order information at a sales base within the sales area. Furthermore, the car-mounted communication terminal may send the sales information to the sales headquarters immediately, and share the predetermined information in the database with the sales headquarters through frequent data exchanges.

The registered communication terminal may receive sales information in response to a call from the car-mounted communication terminal, receive an input of order information from the member user, send the order information to the car-mounted communication terminal, receive sales proportion information from the sales headquarters, and inquire the sales headquarters to obtain desired information.

Furthermore, in the mobile shop service system, a salesperson may go round. Therefore, a round service for in-home care requiring people can be provided.

As described above, according to the present invention, effects can be obtained as follows.

First of all, comfortable services can be provided to member users, such as hearing-impairing people, people who cannot walk, aged people living along, people requiring in-home care.

Providers can buy in large amounts of items and each of mobile shops sells small lots of items in a limited area. Therefore, the prices can be set lower generally than the indiscriminate door-to-door deliveries. The member users can purchase items at the low prices. In addition, each of the member users can receive sales information by using a registered communication terminal at home, which is effective also for general customers in seasons such as winter and hot summer when windows are shut up. Especially, arrival notifications are given not only through sound and/or voice but also visually such as lamp lighting-up and e-mail. Furthermore, when a service for delivering purchased items to a member user is added, a round service can be implemented easily.

Secondly, member users can purchase services certainly. This is because the arrival of the mobile service car is notified in advance from the mobile service car. The member users can request the extension of the parking time before the arrival.

Third, the seller can improve the level of customer satisfaction while using merits of mobile shops.

The previous notification of the arrival can reduce the time for waiting a mobile shop. Furthermore, orders and/or requests can be obtained from customers bi-directionally instead of one-way advertisement. In addition, by analyzing member information and/or item sales trends, flexible route changes and item buying-in are possible.

On the other hand, unlike door-to-door sales, member users do not have to respond to sales notification relating to unnecessary items. Therefore, the security is also protected. Furthermore, the notifications may be transferred to a predetermined address or to a mobile telephone. Therefore, member users can purchase items from the outside of their homes. Even during a meeting, lunches sold at a mobile shop can be purchased.

Fourth, the reliability can be improved. This is because a retailer and a customer can exchange information bi-directionally by providing respective attribute information to each other. Therefore, regular sales are promoted. Furthermore, personalization is also possible.

Fifth, the present system can contribute to the public welfare. This is because mobile shops of the invention do not have to advertise in an unnecessarily loud sound or voice.

Sixth, a seller can obtain members from unlimited areas. This is because each of member users registers an e-mail address as a registered communication terminal such that the member user can receive notifications from the seller by using a mobile personal computer or a mobile telephone terminal. Therefore, the notifications may be received at the use's workplace or outside. Thus, a big order for lunch boxes, for example, can be expected.

Finally, a wide variety of item lines can be provided by forming a mobile shop association or “mobile shopping mall”. The synergistic effect can be expected.

This is because multiple companies or sellers can collaborate to bring their mobile shops or door-to-door services to one system. As a result, service area information, mobile shop know-how and vehicles can be shared easily and reasonably. The service area information is also useful for opening real shops in future. The possibility that customers can purchase items jointly can be increased. By differentiating participating companies based on the days of week and/or seasons, demands of customers can be handled to the detail.

### BRIEF DESCRIPTION OF THE DRAWINGS

FIG. 1 is a block diagram showing an example of a mobile shop service by using a mobile shop service car;

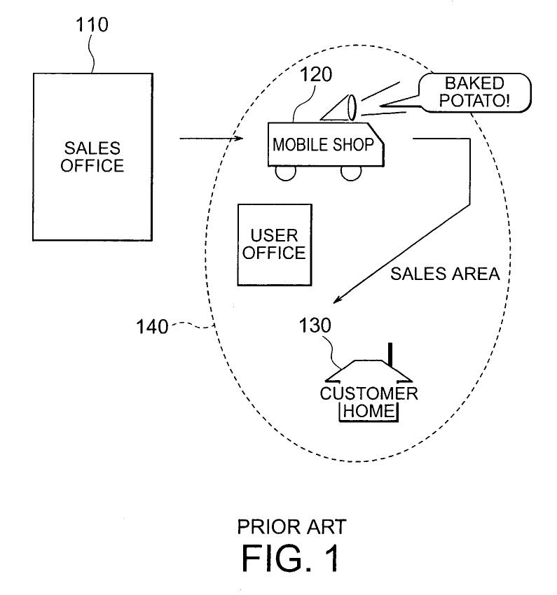

FIG. 2 is a block diagram showing an embodiment in which a mobile service system according to the invention is a mobile shop service system;

FIG. 3 is a block diagram showing the embodiment of the mobile shop by using a mobile shop service car in FIG. 2;

FIG. 4 is a diagram showing a notification screen example to be sent to member users by the mobile shop service car in the vicinity of a mobile shop base;

FIG. 5 is a sequence chart showing illustrative main steps in the mobile shop service in FIG. 3;

FIG. 6 is a block diagram showing an embodiment in which a round service for in-home care requiring people is added to a mobile shop service by using a mobile shop service car; and

FIG. 7 is a sequence chart for explaining illustrative main steps of the round service in FIG. 6.

### DESCRIPTION OF THE PREFERRED EMBODIMENTS

Next, embodiments of the invention will be described with reference to drawings.

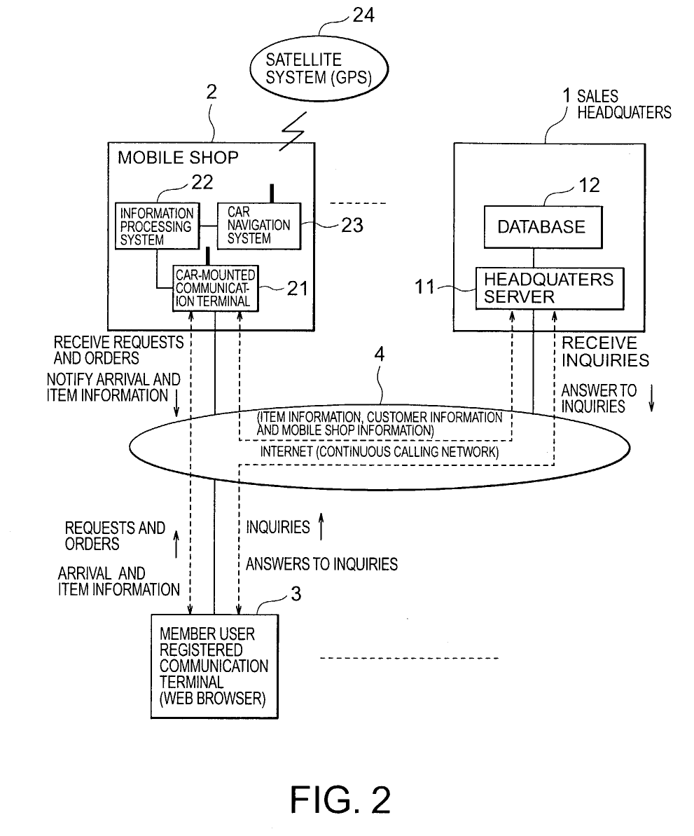

FIG. 2 is a block diagram showing an embodiment in which a mobile service system according to the invention is a mobile shop service system.

A mobile shop service system shown in FIG. 2 includes a sales headquarters 1, a mobile shop 2, which is a mobile shop service car, a registered communication terminal 3 owned by a member user, and the Internet 4, which is a communication network. The sales headquarters 1 has a headquarters server 11 and a database 12. The mobile shop 2 has a car-mounted communication terminal 21, an information processing system 22, and a car navigation system 23.

The sales headquarters 1 functions as a head office of a retailer, for example. The sales headquarters 1 provides a mobile shop service to registered member users by using at least one mobile shop 2.

The headquarters server 11 is an information processing apparatus such as a workstation server. The headquarters server 11 is connected to the Internet 4 continuously. The headquarters server 11 may have a Web site, for example. The database 12 holds item information, customer information, mobile shop information and so on. A staff in the sales headquarters 1 manages the database 12 through the headquarters server 11.

Here, the item information is information relating to retail items, including the inventories, item features, reservations, prices and buying-in. The customer information is information including attributes, special orders, and purchasing history relating to member users. The mobile shop information is information including position information, round routes, amounts of sales, and credit card payment of the mobile shop 2.

Member users can contact and place an order with the headquarters server 11 also when the mobile shop 2 is not available. The headquarters server 11 can receive inquiries, answer to the inquiries and provide information to the mobile shop 2 over the Internet 4.

The mobile shop 2 goes to an assigned sales area in accordance with an instruction from the sales headquarters 1 to provide services.

The car-mounted communication terminal 21 and the information processing system 22 may be installed in a personal computer, which functions as a car-mounted system. A salesperson riding on the mobile shop 2 uses the car-mounted system. The car-mounted system has a Web browser and always exchanges information with the headquarters server 11 over the Internet 4. The car-mounted system shares the latest information in the database 12. On the other hand, registration updates on membership information from member users may be input to the car-mounted system, and the updates may be reflected on the headquarters server 11. Furthermore, the car-mounted system may handle subscriptions for the membership from new users.

The mobile shop 2 includes the car navigation system 23 in the car-mounted system. A global positioning system (GPS) by using a satellite system 24 is used to obtain a current position. Then, when the mobile shop 2 enters to a point located from map information prepared additionally, the car navigation system 23 can send an arrival notification, item information and so on to the registered communication terminals 3 of the applicable member users over the Internet 4. Furthermore, all of the registered communication terminals 3 within a target area may be called together based on information relating to sales areas obtained from the map information and customer information in the database 12. Different types of registration communication terminals, which will be described later, may be called separately by using respective compliant communication functions.

The car-mounted system receives orders and requests from the registered communication terminals 3 of the member users. Furthermore, in sales transaction, the car-mounted system may handle payment by using a card reader function and record purchasing history for each member user.

The registered communication terminal 3 is owned by a member user registered with the service. The registered communication terminal 3 can call and exchange information with the car-mounted communication terminal 21 anytime. For example, a lamp lighting-up terminal for hearing-impairing people, an intercom system terminal including high functions, a facsimile terminal, a personal computer or a mobile phone terminal may be connected to the Internet 4 for use. In other words, the registered communication terminal 3 can notify a member user of a call from the car-mounted communication terminal 21 in response to a predetermined call signal. Therefore, the registered communication terminal 3 of a member user is connected to the Internet 4 continuously so as to receive an arrival notification from the mobile shop 2 at all times.

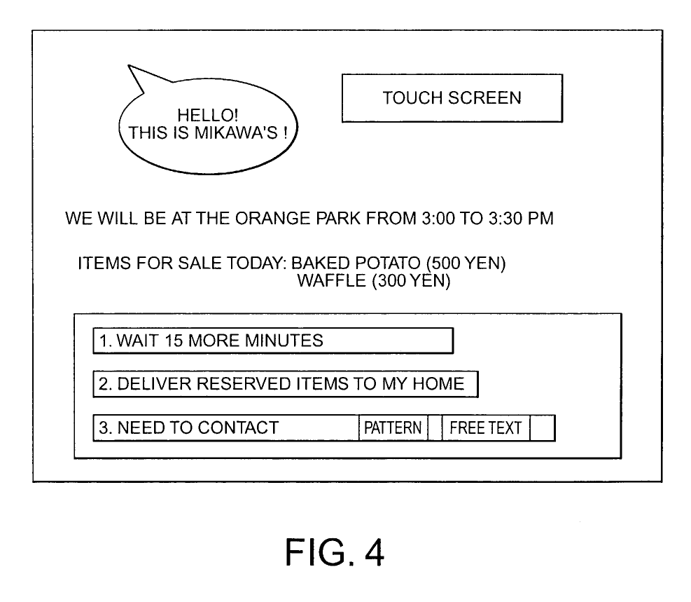

The lamp light-up terminal for hearing-impairing people may light up or flash a lamp to indicate that information has been received. The intercom system terminal may light up a lamp, output an alarm sound such as chimes or output voice to indicate that information has been received. The facsimile terminal may light up a lamp or output an alarm sound or voice to indicate that information has been received. An e-mail available personal computer, which is a communication terminal, may light up a lamp or output an alarm sound or voice to indicate that information has been received. Alternatively, a mobile telephone terminal may output a vibration alarm to indicate that information has been received. Once answered, each of these terminals displays, on the screen, item information and arrival information as shown in FIG. 4. Furthermore, the facsimile terminal can print information on facsimile paper.

For example, a communication terminal such as the mobile telephone terminal and the facsimile terminal is connected to a private network continuously. Thus, the communication terminal can be called by using a terminal number like a telephone number. The personal computer must be directly connected to a network by keeping the power on. Each of these registered communication terminals 3 desirably has a Web browser so as to interface with the Internet 4. Furthermore, the registered communication terminals 3 are desirably registered with an e-mail system so as to have an e-mail function.

However, necessary information can be delivered even to general telephones when the mobile shop 2 includes the compliant facility to automatically send out voice messages, for example. Therefore, the mobile shop 2 includes, in the car-mounted system, communication devices compliant with types of the registered communication terminals of member users, respectively.

The Internet 4 includes a telephone network, a facsimile-only network and a communication network, such as a local area network, to which registered communication terminals of member users are connected.

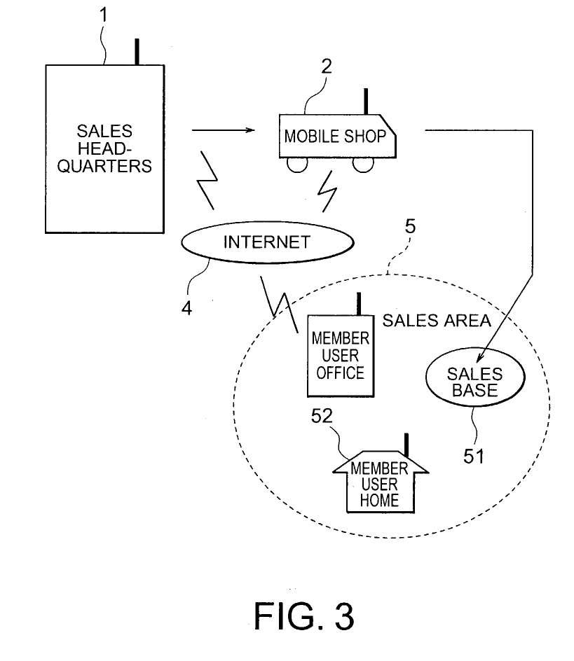

FIG. 3 is a diagram showing an example of the mobile shop service by using the mobile shop 2.

An outline of the mobile sales by using the mobile shop 2 will be described with reference to FIGS. 2 and 3.

The sales headquarters 1 instructs the mobile shop 2 to go to a sales area 5 in accordance with a created sales plan. The mobile shop 2 goes to the sales area 5 in accordance with the car navigation system 23. When the mobile shop 2 approaches the sales area 5, the mobile shop 2 calls and distributes previous notification of the arrival and item information to the registered communication terminals 3 within the sales area 5. Then, the mobile shop 2 arrives at a predetermined sales base 51.

FIG. 4 is a diagram showing a screen example displaying item information to be distributed by the mobile shop 2. The shown screen is included in a screen-displayable communication terminal, such as a personal computer and a mobile telephone terminal, and displays sales places, times, names and prices of items, and other requested items.

A member user can view the displayed information shown in FIG. 4 at a member user home 52 by using the registered communication terminal 3. Therefore, the member user can reserve a desired item and can request to extend the parking time of the mobile shop 2. In addition, a member user can reserve the other items, which are not on the mobile shop 2 at that time. This information can be registered in the database 12 through frequent data exchanges with the sales headquarters 1.

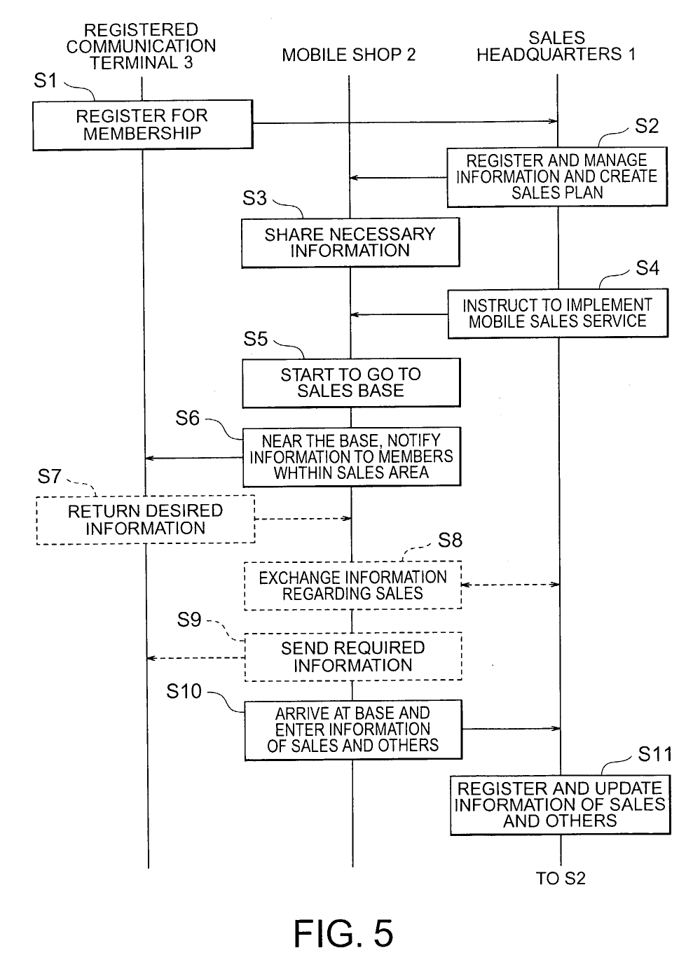

Next, illustrative steps of a main operation will be described with reference to FIG. 5 as well as FIGS. 2 to 4. Here, the registered communication terminal 3 of a member user is an information terminal having a Web browser. Continuously, the registered communication terminal 3 is connected to the Internet 4 and is powered on.

First of all, a user uses the information terminal having a Web browser to access a Web site established on the Web by the sales headquarters 1. Then, the user registers (step S1) for the membership to receive the service. At the completion of the registration, the user is provided with his/her ID (identifier) and password (PW) and becomes a member user. The e-mail address of the used communication terminal is registered and then the user can obtain his/her registered communication terminal 3.

The headquarters server 11 in the sales headquarters 1 accepts the member registration. Here, the headquarters server 11 registers the member information relating to the member user and the registered communication terminal in the database 12 as customer information. Additionally, the headquarters server 11 registers information on items for sale with the database 12 as item information. The headquarters server 11 manages these kinds of registration information and creates a mobile shop plan based on the registered information (step S2).

As described above, the member user can access the headquarters server 11 by using the registered communication terminal 3 to reserve an item, for example. In this case, the headquarters server 11 can record the reservation in the database 12 as customer information.

A mobile shop schedule of the mobile shop plan is created by determining sales areas 5 and sales bases 51 within the sales areas 5 for each of the mobile shops 2 based on customer information of member users and map information. The registration information in the database 12 is transferred to each of the mobile shops 2 and is shared (step S3). In other words, new information is exchanged with each other when a new registration, a registration update and/or the like occur. Furthermore, the information is managed by the headquarters server 11 extensively by checking registration contents regularly.

The sales headquarters 1 instructs the mobile shops 2 to implement services based on the created mobile shop plan (step S4).

Items for sale are loaded on the mobile shop 2 in accordance with the instruction from the sales headquarters 1. Then, the mobile shop 2 starts to move toward the sales base 51 (step S5). When the mobile shop 2 approaches the target sales base 51, a salesperson calls by e-mail to all of the registered communication terminals 3 in the target sales area 5 by using the car-mounted communication terminal 21. Thus, a previous notification of the arrival and item information are distributed to the registered communication terminal 3 (step S6).

When the registered communication terminal 3 is being used at the member user home 52, a predetermined e-mail alert and an indicator are displayed on the screen for indicating that an e-mail has been received. When the registered communication terminal 3 displays a screen saver, the received information is displayed on the screen. When the member user responses thereto, a screen as shown in FIG. 4 is displayed.

When the member user needs to contact the mobile shop 2 after receiving the screen, the member user may select a pre-defined message such as “wait for 15 minutes” and “deliver the reserved items to my home” or may input a message freely. Then, the member user returns the message to the mobile shop 2 (step S7). In order to manage the contact information, the returned information may be sent to the headquarters server 11 also.

In this system, the member user can enter desired matters from the screen. Therefore, if door-to-door deliveries are available to customers who cannot go out, the member user can also input either receiving reserved items at the sales base or at home or can request home delivery in advance.

At the mobile shop 2, the salesperson follows the contents of the received message and uses the car-mounted communication terminal 21 to exchange information with the headquarters server 11 if necessary (steps S8). Thus, the reply information can be obtained. Then, the salesperson sends the returned information required in the received message (step S9). When no communication occurs during a certain period of time from the mobile shop 2, a pattern message may be automatically sent by the headquarters server 11, for example.

When the mobile shop 2 arrives at a predetermined sales base, the salesperson uses the car-mounted communication terminal 21 to connect to the headquarters server 11. Then, the salesperson checks sales, received reservations, member registrations and inventory/item information. Data including sales amounts are input to the car-mounted communication terminal 21 (step S10) and are sent to the headquarters server 11 over the Internet 4 immediately.

The headquarters server 11 registers the received data in the database 12 and updates the database 12 if necessary (step S11). Then, points may be issued to a member card, for example.

The headquarters server 11 returns to the step S2 and orders items for the next sale based on the received data. Then, the headquarters server 11 registers and manages different kinds of information such as purchasing histories and service points and creates the next mobile shop plan.

As described above, in the mobile shop service system, a salesperson may use the mobile shop service car to make rounds. Furthermore, a salesperson and a member user may use communication terminals to communicate bi-directionally. Therefore, a round service may be additionally provided for checking health of in-home care requiring people.

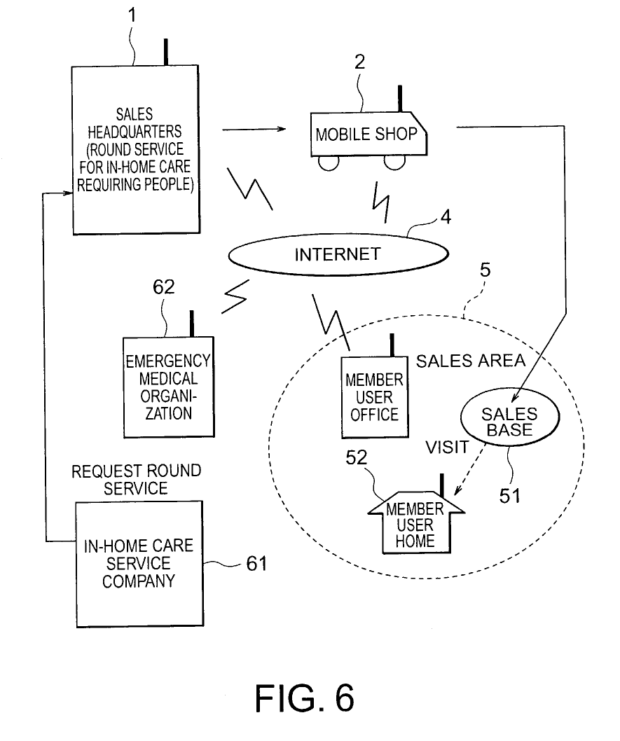

Next, a round service for in-home care requiring people such as aged people and disabled people living alone will be described with reference to FIG. 6. In this case, the round service is provided in addition to the mobile shop service described with reference to FIGS. 3 and 5.

In this system, an in-home care service company 61 or an organization or individual user requests a sales headquarters 1 a round service for in-home care needing people such as aged people and disabled people living alone. The members of the in-home care service company 61 are registered. Then, when their health cannot be checked in the round service, a salesperson of a mobile shop 2 visits a member user home 52. If necessary, the salesperson may contact an emergency medical organization 62 and request an ambulance.

Especially, a catering service may be provided to in-home care requiring people for catering foods to cook, which are items for sale in the mobile shop. In this case, the member users may receive the mobile shop service basically. Receiving the round service needs another registration. However, apparently, only one of the registrations may be necessary.

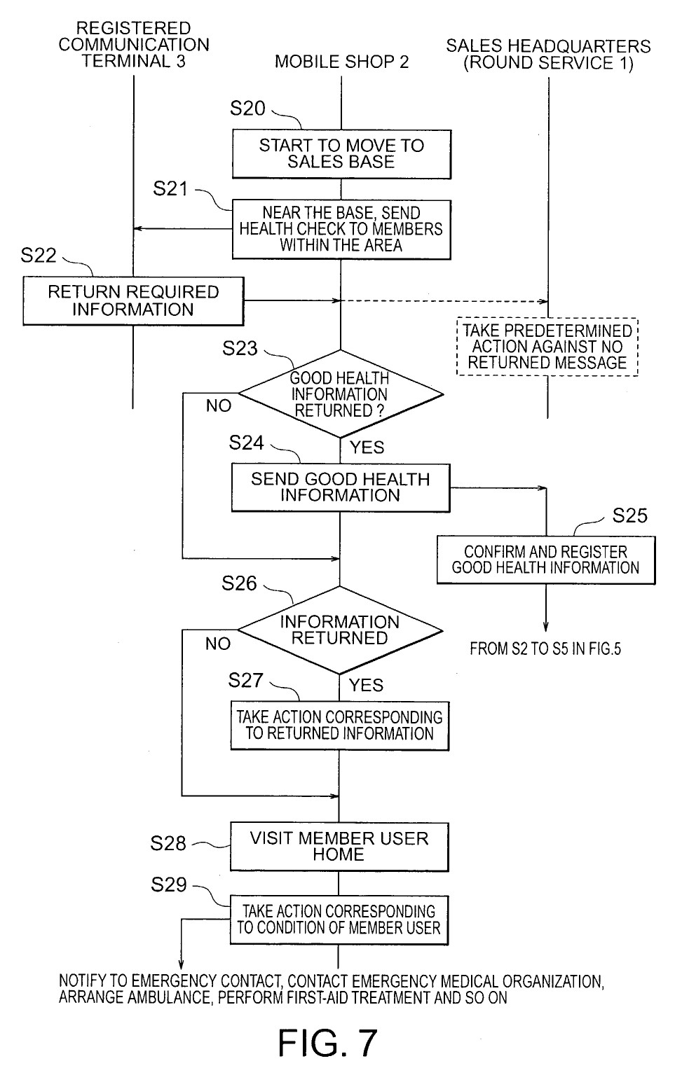

Next, with reference to FIGS. 6 and 7 as well as FIGS. 2 and 5 a case will be described where both of the mobile shop service and the round service for in-home care requiring people are provided. For simple description, the step S5 in FIG. 5 and subsequent steps in FIG. 7 are only for member users registered with the round service. Each of the member users registers with either one of the round service and the mobile shop service here.

First of all, the beginning steps are the same as the steps S1 to S4 described with reference to FIG. 5. In other words, a user to receive the round service has already registered with the membership in the headquarters server 11 at the sales headquarters 1. Member information required for the service is registered in the database 12 as customer information.

In other words, the in-home care service company 61 or an organization or individual user accesses the headquarters server 11 from a communication terminal to regularly receive the round service. Thus, for example, member information such as attributes, desired round time zone and long-term absence schedules can be registered therein as customer information. Therefore, a mobile sales plan for the mobile shop 2 is determined in view of the round information. The sales headquarters 1 instructs the mobile shop 2 to provide the services based on the determined mobile sales plan.

The mobile shop 2 starts to move toward the sales base 51 in accordance with the instruction of the headquarters server 11 of the sales headquarters 1 (step S20). When the mobile shop 2 approaches the target sales base 51, a salesperson calls, by e-mail, all of the registered communication terminals 3 within the target sales area 5 together. Thus, a previous announcement of the arrival and item information are distributed to the member users registered with the mobile shop service. On the other hand, health checks of the member users are distributed and are notified to the member users registered with the round service (step S21).

When the registered communication terminal 3 is in use at the member user home 52, a predetermined e-mail alert and an indicator are displayed on the screen for indicating that an e-mail has been received. When the registered communication terminal 3 displays a screen saver, the incoming-call information is displayed on the screen. When the member user responses thereto, a predetermined screen is displayed. In response to the contents of the information on the screen, the member user returns required information by using a pattern message such as “in good health” and “come and check my health” or by entering a message freely (step S22). The returned message is sent to both of the headquarters server 11 and the car-mounted communication terminal 21 in the mobile shop 2, which is the round car.

If the car-mounted communication terminal 21 receives the returned message indicating good health (YES at a step S23), the fact is notified to the headquarters server 11 (step S24). The headquarters server 11 also receives the good health information from the registered communication terminal 3 directly. However, the step S24 updates and registers a good-health confirmed time of the customer information in the database 12 (step S25).

If NO at the step S23, and if the car-mounted communication terminal 21 receives the other information than the good-health information (YES at a step S26), proper processing is performed (step S27) such as responding to the returned message if necessary. For example, after taking an emergency reaction to the returned message, the salesperson of the mobile shop 2 may visit the requesting member user home 52. Then, the salesperson records the user's condition and sends the related data to the headquarters server 11 by using the car-mounted communication terminal 21.

If NO at the step S26 and if the car-mounted communication terminal 21 does not receive any message from the registered communication terminal 3 for a predetermined period of time, the salesperson of the mobile shop 2 contacts a registered emergency contact such as a family of the member user by using a telephone or by e-mail. Then, the mobile shop 2 visits the member user home 52 as a round service car (step S28). If necessary, a predetermined action, such as calling an ambulance, is taken in accordance with the condition (step S29).

On the other hand, the headquarters server 11 receives a notification indicating the mobile shop 2 has arrived at the sales base 51 from the car-mounted communication terminal 21 of the mobile shop 2. Therefore, if no messages are returned from the registered communication terminal 3 for a predetermined period of time and when no notifications are received also from the car-mounted communication terminal 21, a predetermined pattern message is automatically sent to the car-mounted communication terminal 21. Then, the situation is notified.

Based on the periodic round data, the sales headquarters 1 creates a menu for recommending different kinds of services. Then, the created menu is reported to the round service company or organization. In addition, the services are proposed to the member users or the families.

In the description above, the round service of the mobile shop service company is requested from the round service company or organization. However, the mobile shop service company may recruit members for the round service as one business section of the mobile shop service company. Furthermore, the mobile shop service company may have an individual system configuration or service form for providing the round service only by using the mobile shop as a round service car.

On the other hand, in the specific example described with reference to the drawings, the registered communication terminal of the member user is a personal computer. However, the other kinds of communication terminals may be used.

In other words, a terminal connected to a telephone line may function like a personal computer if the terminal has an e-mail function by using an Internet protocol and has a display screen, though the size of the screen is limited.

On the other hand, a terminal without a display screen, such as a general telephone terminal, may achieve the desired purposes. In that case, the car-mounted communication terminal has an automatic transmission function and an automatic response function to a telephone network. In the automatic response mode, a salesperson may respond to a required call. Thus, a bi-directionally communication can be implemented.

The above description refers to the shown function blocks and steps. However, changes such as distribution of functions by dividing and/or merging and switching the order of the steps may be given freely as far as the above-described functions are satisfied. The above description does not limit to the present invention. Furthermore, the present invention is generally applicable to service businesses using vehicles.

What is claimed is:

1. A mobile service system for providing a mobile service to user by using a mobile service car, the system comprising:
a communication network;
a car-mounted communication terminal, which is mounted in the mobile service car, for holding service information, customer information and mobile service information in a database in advance, connecting to the communication network and having an information processing function; and
a registered communication terminal of a member user, which is registered with the mobile service by the user as the member user in advance, for bi-directionally communicating with the car-mounted communication terminal over the communication network.

2. A mobile service system according to claim 1,
wherein the mobile service car has a car navigation system;
wherein the car-mounted communication terminal registers a point in a given service area with the car navigation system in advance; and
wherein, when the mobile service car approaches the registered point, the registered communication terminal within the service area is read from the database and is called over the communication network.

3. A mobile service system according to claim 1, wherein the registered communication terminal is one of terminals including a lamp lighting-up terminal for hearing-impairing people, an intercom system terminal including high functions, a facsimile terminal, a personal computer and a mobile phone terminal;
wherein the registered communication terminal has an e-mail function using the communication network and immediately notifies to the member user in response to a predetermined call signal when the registered communication terminal is called from the car-mounted communication terminal; and
wherein the car-mounted communication terminal has an interface function for interconnecting with registered communication terminal to be called.

4. A mobile service system according to claim 1, wherein the registered communication terminal causes at least one of lighting-up of a light source, sound, voice, and vibration as a predetermined call signal when the registered communication terminal is called from the car-mounted communication terminal and stops the call signal when the member user responds thereto, receives distributed information, and outputs the received information at least one of through voice and on the screen.

5. A mobile service system according to claim 1,
wherein the mobile service car is a mobile shop, the mobile service is a mobile shop service and the service information is item information;
wherein, when the mobile shop approaches a predetermined sales area, the car-mounted communication terminal calls and distributes sales information to the registered communication terminal of at least one member user within the sales area, receives order information for the sales information and collects and records information on sold-item information input by a salesperson based on received order information at a sales base within the sales area; and
wherein the registered communication terminal receives sales information in response to a call from the car-mounted communication terminal, receives an input of order information from the member user and sends the order information to the car-mounted communication terminal.

6. A mobile service system according to claim 5, further comprising a sales headquarters for holding items information, customer information and mobile shop information in a database in advance,
wherein the sales headquarters registers, in the customer information, a predetermined registration requested by a communication terminal of a user, distributes sales promotion information to the registered communication terminal as required, answers to an inquiry from the registered communication terminal, registers predetermined information received from the car-mounted communication terminal in the database, updates the predetermined information in the database as necessary, and shares the registered data with the car-mounted communication terminal;
wherein the car-mounted communication terminal sends sales information collected and recorded at the sales base within the sales area to the sales headquarters immediately, and shares the predetermined information in the database with the sales headquarters through frequent data exchanges; and
wherein the registered communication terminal receives sales promotion information from the sales headquarters as required and inquires the sales headquarters to obtain desired information.

7. A mobile service system according to claim 5, wherein the mobile shop service further provides a round service for in-home care requiring people; and
wherein, when the user requests and registers with the round service in advance, and when the mobile shop approaches a predetermined sales area, the car-mounted communication terminal calls and distributes health check information to the registered communication terminal of at least one member user registered with the round service in the sales area, receives response information to the health check information, sends a predetermined signal when no responses are received to the health check information and prompts a salesperson responsible for operating the car-mounted communication terminal to take a predetermined action corresponding to a given situation.

8. A mobile service system according to claim 1, wherein the mobile service car is a round service car, and the mobile service is a round service;
wherein, when the mobile shop approaches a predetermined sales area, the car-mounted communication terminal calls and distributes health check information to the registered communication terminal of at least one member user registered with the round service in the sales area, receives response information to the health check information, sends a predetermined signal when no responses are received to the health check information and prompts a salesperson responsible for operating the car-mounted communication terminal to take a predetermined action corresponding to a given situation.
